(19) United States
(12) Patent Application Publication
(10) Pub. No.: US 2003/0105832 A1
(43) Pub. Date: Jun. 5, 2003

(54) Information providing system

(75) Inventor: Koichi Kaneko, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/136,309

(22) Filed: May 2, 2002

(30) Foreign Application Priority Data
Dec. 4, 2001 (JP) 2001-370563

(51) Int. Cl. G06F 15/16

(52) U.S. Cl. 709/217

(57) ABSTRACT

In the information providing system, when providing environmental impact data, a server of an information provider requests a user ID and a password from an information requestor, and compares a user ID and a password transmitted from a computer of the information requestor with previously stored user ID and password to verify the information requestor as an authorized requestor. After the verification, the server displays a plurality of environmental impact calculation programs and output forms, and provides environmental impact data by using an environmental impact calculation program and an output form selected by the requestor.

### FIELD OF THE INVENTION

The present invention relates to an information providing system which provides data on environmental impact.

### BACKGROUND OF THE INVENTION

Problems of the environment are taken up extensively on a global scale. Germany is famous as an environmental advanced nation. In Japan as well, various laws for the environment, such as the Basic Environment Law, Environmental Impact Assessment Law, and Green Purchase Law, have been established. The Green Purchase Law states that industrial companies and citizens are in duty bound to select products which are lighter in environmental load, and requires manufacturers to provide suitable information of raw materials, parts, and products (environmental goods) useful for reduction of the environmental load, as reference data for product selection.

In this context, inquiry as to the environmental information of each product from users needs to be coped with rapidly. However, when calculating discharge into the environment (such as energy conservation, amount of CO₂ exhausted, resource consumption, environmental impact fear substance quantity) generated in all processes ranging from supply of raw materials to product abandonment through part working, product manufacturing, and product operation by using the life cycle assessment (LCA) technique, and providing environmental impact data such as environmental load indexes classified into categories, such as global warming and ozone layer destruction, a large number of fundamental numerical values are needed to conduct concrete calculations.

If persons in charge in respective posts individually conduct such works and cope with inquiries from users by letters, it takes a lot of time and a considerable burden is cast upon each person in charge.

Depending upon the selection of items of fundamental numerical values and calculation equations in use, the environmental impact data also change. If persons in charge vary according to products, unification of provided environmental impact data also becomes difficult.

In order to improve these problems, such a system as follows has been introduced. That is, this system can perform centralized management by forming a database of items and fundamental numerical values required for calculation of environmental impact data, and provide environmental impact data by connecting a server which previously stores the created database and a program of calculating the environmental impact data to a computer of a party that makes a request for obtaining the information (“an information requestor”) via a communication line.

A related system which provides environmental impact data by using the Internet is disclosed in Japanese Patent Application Laid-Open (JP-A) No. 11-219391 or JP-A No. 2001-155079.

In the prior art system disclosed in JP-A No. 11-219391, databases respectively corresponding to categories, such as products, units, parts, and materials, are stored in the server, and environmental impact data are calculated by using the data stored in the databases. Event analysis results and impact assessment results are displayed. In addition, the number of times of use are counted for each user, and notices concerning a service charge, alteration of service contents and so on, can be given.

In the prior art system disclosed in JP-A No. 2001-155079, the server stores databases of respective processes of respective products, and calculates the environmental impact data on the basis thereof. The environmental impact data can be displayed separately for respective processes, such as at the time of use and at the time of manufacturing.

In the above-described prior art systems, centralized management is made possible by forming a database of items and fundamental numerical values required for calculation of environmental impact data, and one calculation equation is used to reduce the burden of the person in charge and unify environmental impact data to be provided. However, security has not been considered. Although the law demands provision of environmental information, the environmental impact data are important data in the same way as the product quality, and it poses a problem to provide anyone with the environmental impact data via the Internet.

Further, a computer program for calculating the environmental impact data is different for different makers. Therefore, for example, when parts are purchased and combined with parts of other makers to produce a new product, environmental impact data which are not unified for respective parts are combined to create environmental impact data of the new product. There is a problem about provision of the environmental impact data of that product as well.

### SUMMARY OF THE INVENTION

It is an object of the present invention to provide an information providing system which provides only authorized information requestors with environmental impact data for the purpose of ensuring the security, makes it possible to make a selection from a plurality of programs which calculates environmental impact data and a plurality of output forms, and thereby provides environmental impact data desired by an information provider.

The information providing system according to this invention information provides environmental impact data by connecting a server of an information provider, which previously stores an environmental impact calculation program and databases of respective products required for the environmental impact calculation program, to a computer of an information requestor via a network to accomplish mutual communication. When providing environmental impact data, the server requests a user ID and a password, compares the user ID and the password transmitted from the computer with registered user ID and password stored in a user information file to verify the information requestor as an authorized information requestor, and provides the authorized information requestor with environmental impact data.

According to the above-mentioned aspect, the server of the information provider provides information requestor with environmental impact data upon verifying that the information requestor is an authorized requestor by requesting the user ID and password and comparing the user ID and password transmitted from the computer of the information requestor with previously stored user IDs and passwords.

Other objects and features of this invention will become apparent from the following description with reference to the accompanying drawings.

### BRIEF DESCRIPTION OF THE DRAWINGS

FIG. 1 is a diagram showing a configuration of the information providing system according to a first embodiment of this invention,

FIG. 2 is a diagram showing a configuration of a server shown in FIG. 1,

FIG. 3 is a flow chart showing operation of the information providing system of the first embodiment,

FIG. 4 is a diagram showing an example of a display screen of the information providing system of the first embodiment,

FIG. 5 is a flow chart showing operation of an information providing system according to a second embodiment of this invention,

FIG. 6 is a flow chart showing operation of an information providing system according to a third embodiment of this invention, and

FIGS. 7A and 7B are diagrams showing an example of an output form of the information providing system of the third embodiment.

### DETAILED DESCRIPTIONS

Embodiments of the information providing system according to the present invention will be explained in detail below by referring to the accompanying drawings.

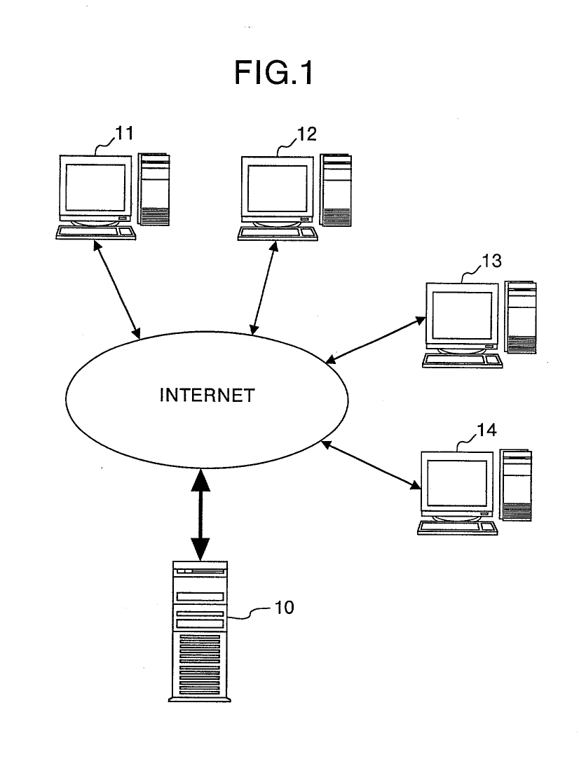

A first embodiment of the present invention will be explained by referring to FIGS. 1 to 4. In this embodiment, a server of an information provider and a terminal of an information requestor each connected to a network such as the Internet via a communication line conduct mutual communication. When the information requestor has accessed the server in order to acquire environmental impact data, the server compares a user ID and a password input through the terminal by the information requestor with registered user ID and password previously stored. Upon thus verifying that the information requestor is an authorized information requestor, the server provides environmental information data.

FIG. 1 is a block diagram showing a configuration of the information providing system of the first embodiment. In the information providing system of the first embodiment, a server 10 on the information provider side and a plurality of terminals 11 to 14 (four terminals in this case) on the information requestor side are connected to the Internet each via a communication line so as to be able to conduct mutual communication.

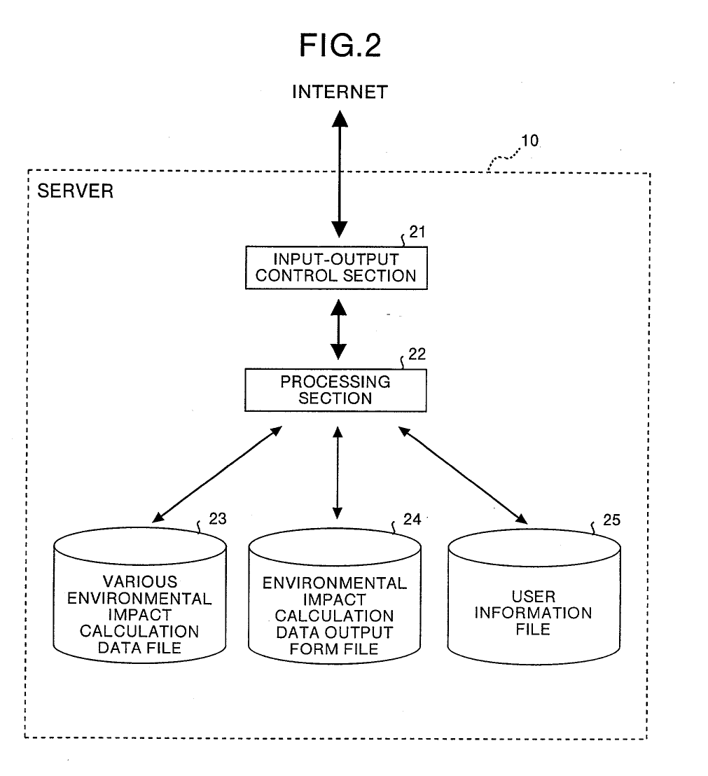

FIG. 2 is a block diagram showing a configuration of the server 10 shown in FIG. 1. The server 10 includes an input-output control section 21, a processing section 22, a various environmental impact calculation data file 23, an environmental impact calculation data output form file 24, and a user information file 25.

The input-output control section 21 controls communication with a terminal connected via the Internet. The processing section 22 conducts calculation processing of environmental impact calculation data and control of respective components of the server in a centralized manner.

The various environmental impact calculation data file 23 stores a plurality of environmental impact calculation programs and data required for calculation of environmental impact data. The environmental impact calculation data output form file 24 stores output forms in which a plurality of environmental impact calculation data is displayed. The user information file 25 stores user IDs and passwords of registered users and user information at the time of registration.

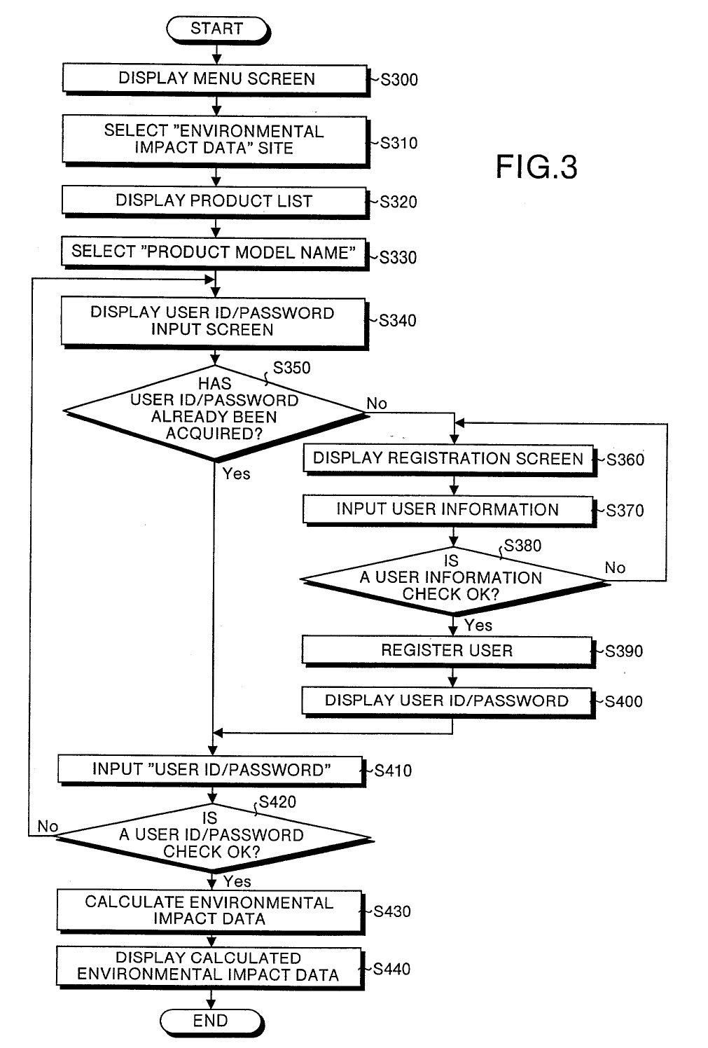

Operation of the information providing system of the first embodiment will now be explained by referring to the flow chart of FIG. 3.

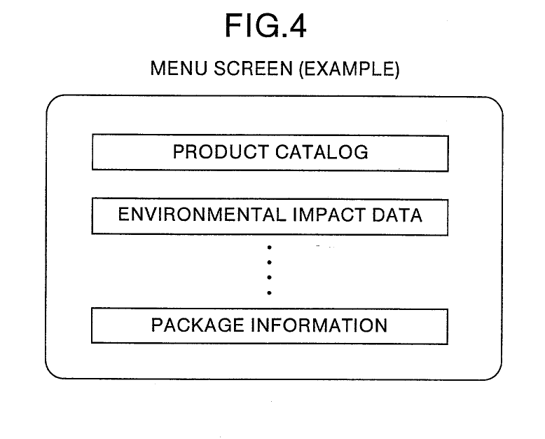

An information requestor who needs environmental impact data connects a terminal 11 to the Internet, to which the server 10 of the information provider is connected via a communication line. The server 10 conducts communication with the terminal 11 via the input-output control section 21. Upon completion of the connection between the server 10 and the terminal 11, the server 10 displays a menu screen on the terminal 11 (step S300). FIG. 4 shows an example of the menu screen displayed on the terminal 11. Items such as a product catalog, environmental impact data, and package information are displayed on the menu screen, and they can be selected on the terminal 11 by using a mouse or the like. The information requestor selects the environmental impact data site on the menu screen (step S310).

Upon selection of the environmental impact data site, the server 10 displays a list of products whose environmental impact data can be provided, on the terminal 11 (step S320). The information requestor selects a desired product model name from the displayed product list (step S330).

Upon specification of the product model name, the server 10 displays an input frame of a user ID and a password on the terminal 11 (step S340). If the information requestor does not have a user ID and a password (No at step S350), then the information requestor selects a user registration screen and the server 10 displays the user registration screen (step S360). Upon the user registration screen being displayed on the terminal 11, the information requestor inputs user information (step S370). Items such as mail address, address, name, telephone number, company name, post are provided in the user information. Items of questionnaire such as a product field of interest may also be provided. If all items have been input, the server 10 checks for an omission or a miss in filling out required items. If there is an omission or a miss in filling out (No at step S380), then the server 10 displays the registration screen again. If all of required items are input and there are no problems (Yes at step S380), then the server 10 determines a user ID and a password, and registers the user ID and the password together with the input user information in the user information file (step S390), and displays the user ID and the password on the terminal 11 (step S400). In this way, a new information requestor inputs user information, conducts registration processing with the server, and acquires a user ID and a password.

On the other hand, if the information requestor already has a user ID and a password (Yes at step S350), the information requestor inputs the user ID and the password (step S410) The server 10 compares the input user ID and password with the user ID and password stored in the user information filed 25, and verifies that the information requestor is an authorized information requestor (step S420). Upon verifying that the information requestor is the authorized information requestor, the processing section 22 reads out a calculation program and data from the various environmental impact calculation data file 23, and calculates environmental impact data (step S430). The result of calculation is displayed on the terminal 11 in accordance with an output form read out from the environmental impact calculation data output form file 24 (step S440).

Thus, according to the first embodiment, the server of the information provider requests the user ID and password from the information requestor when providing the environmental impact data, and compares the user ID and password transmitted from the computer of the information requestor with the previously stored user ID and password to verify the information requestor as an authorized information requestor. The server then provides the environmental impact data to the information requestor. Therefore, the information requestor becomes definite, and thereby the security is ensured.

Further, according to the first embodiment, the server of the information provider requests user information from a new information requestor having no user ID and password. The user registers the user information in the server of the information provider and the server then issues a user ID and a password. Therefore, the information requestor becomes definite. In addition, the user information of the information requestor can be obtained, which may help perform sales promotion of products.

While the server delivers the user ID and password in the explanation of the first embodiment, the server may deliver only the user ID, prompt the information requestor to input a password, and verify and register it.

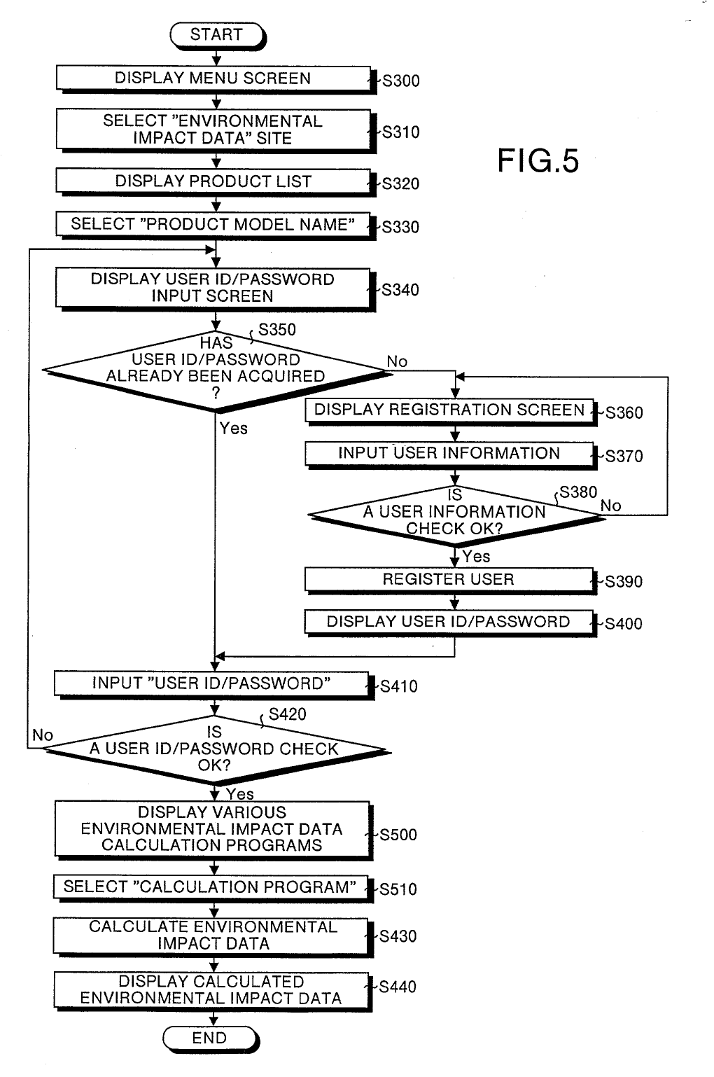

A second embodiment of the present invention will now be explained by referring to FIG. 5. In this embodiment, a plurality of computer programs using which the environmental impact data are calculated are prepared in the server of the information requestor, and environmental impact data is provided by using a program desired by the information requestor.

A configuration of the information providing system is the same as that of FIG. 1, and a configuration of the server 10 is the same as that of FIG. 2. Therefore, explanation thereof will be omitted.

Operation of the second embodiment will be explained by referring to the flow chart of FIG. 5. Operation in the steps S300 to S420 in this figure is the same as that in the first embodiment. More specifically, the operation in the steps is such that the information requestor connects the terminal 11 to the server 10 of the information provider via communication lines and the information requestor is verified as an authorized information requestor. Therefore, detailed explanation of the steps will be omitted.

The information requestor connects the terminal 11 to the server 10 in the same way as the operation of the first embodiment, and the information requestor is verified as an authorized information requestor (steps S300 to S420). Upon verifying that the connected terminal 11 is the authorized information requestor, the server 10 displays a list of environmental impact calculation programs, which is stored in the various environmental impact calculation data file 23, on the terminal 11 (step S500). The information requestor selects a desired program from the programs displayed on the terminal 11 (step S510). The processing section 22 reads out the selected program and data required for calculation from the various environmental impact calculation data file 23, and calculates environmental impact data (step S430). The result of calculation is displayed on the terminal 11 in accordance with an output form read out from the environmental impact calculation data output form file 24 (step S440).

Thus, in the second embodiment, a plurality of environmental impact data calculation computer programs are prepared previously in the server of the information provider, and one of the programs is selected to calculate environmental impact data. Therefore, the information requestor can obtain environmental impact data by using a desired environmental impact data calculation program.

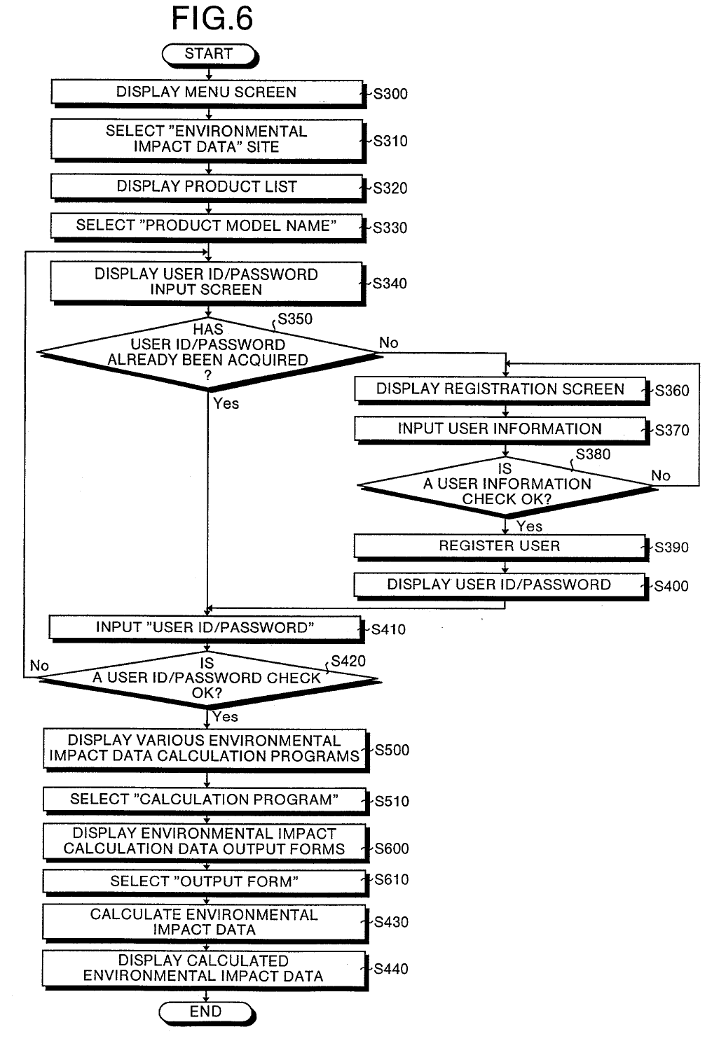

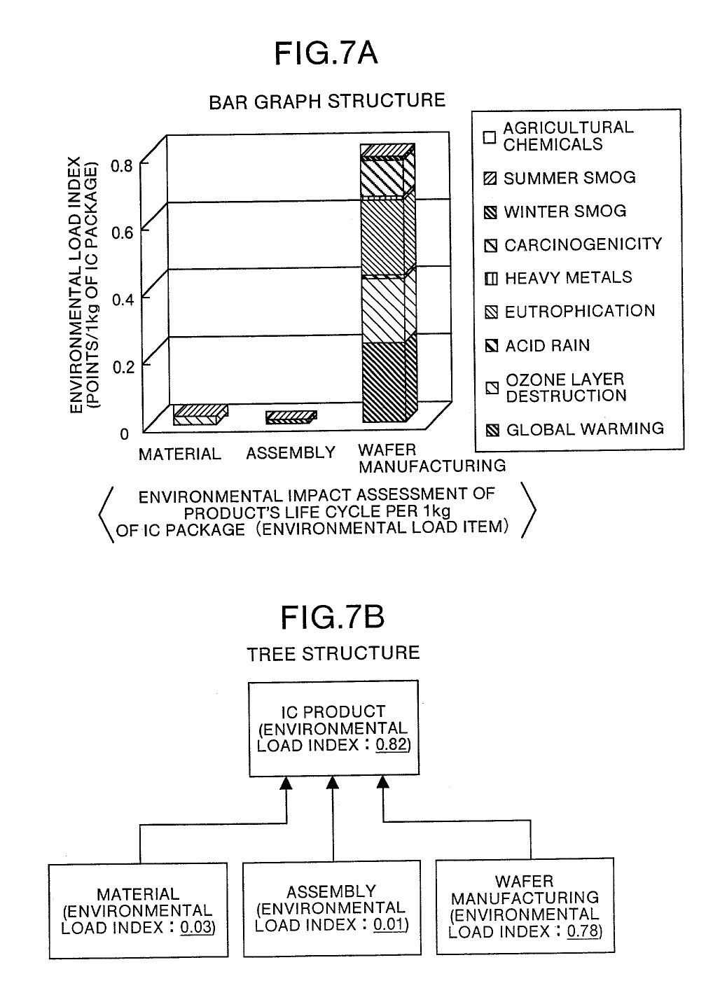

A third embodiment of the present invention will be explained by referring to FIGS. 6 and 7. In this embodiment, a plurality of output forms of environmental impact data are stored previously in the server of the information provider, and environmental impact data is provided in an output form desired by the information requestor.

FIGS. 7A and 7B are diagrams showing an example of the output form of environmental impact data. Both FIGS. 7A and 7B show environmental impact data per kg of IC packages. In FIG. 7A, IC packages are classified into items of material, assembly, and wafer manufacturing, and environmental load indexes are shown in a bar graph structure for each of categories, such as agricultural chemicals and summer smog, which impact on the environment in respective processes. FIG. 7B shows details of the environmental load index of a product in a tree structure. Besides, energy conservation, emitted CO₂ quantity, resource consumption, quantity of environmental impact fear substance and so on may also be shown. A plurality of such output forms are prepared, and therefore the information requestor can select an output form in which environmental impact data is displayed.

A configuration of the information providing system is the same as that shown in FIG. 1, and a configuration of the server 10 is the same as that shown in FIG. 2. Therefore, explanation thereof will be omitted.

Operation of the third embodiment will now be explained by referring to a flow chart of FIG. 6. The operation in the steps S300 to S510 in this figure is the same as that of the second embodiment. More specifically, the operation in the steps is performed since the information requestor connects the terminal 11 to the server 10 of the information provider via communication lines until the information requestor conducts selection on the various environmental impact data calculation programs. Therefore, detailed explanation thereof will be omitted.

In the same way as the operation of the second embodiment, the information requestor connects the terminal 11 to the server 10, inputs the user ID and password, and conducts selection on various environmental impact calculation programs (steps S300 to S510). The server 10 displays the environmental impact calculation data output forms, which are stored in the environmental impact calculation data output form file 24, on the terminal 11 (step S600). The information requestor selects a desired output form from the output forms displayed on the terminal 11 (step S610). The processing section 22 reads out the selected program and data required for calculation from the various environmental impact calculation data file 23, calculates environmental impact data (step S430), reads out the selected output form from the environmental impact calculation data output form file 24, and displays the environmental impact data in accordance with the output form on the terminal 11 (step S440).

Thus, in the third embodiment, a plurality of output forms to be used to display environmental impact data are previously prepared in the server of the information provider, and the information requestor selects one of the output forms to display the environmental impact data. Therefore, the information requestor can obtain the environmental impact data in the desired output form.

As explained above, according to this invention, the server of the information provider requests the user ID and password from the information requestor when providing the environmental impact data, and compares the user ID and password transmitted from the computer of the information requestor with previously stored user IDs and passwords. Upon verifying that the information requestor is an authorized information requestor, the server provides the environmental impact data. Therefore, the information requestor becomes definite, and the security is ensured.

Moreover, the server of the information provider requests user information from a new information requestor having no user ID and password, registers the user information in the server, and then issues a user ID and a password to the information requestor. Therefore, the information requestor becomes definite and thereby the security is ensured. In addition, since the user information of the information requestor can be obtained, which may help perform sales promotion of products.

Furthermore, a plurality of environmental impact data calculation programs are prepared previously in the server of the information provider, and an information requestor is made to select one of the programs to calculate environmental impact data. Therefore, the information requestor can obtain environmental impact data by using a desired environmental impact data calculation program.

Moreover, a plurality of output forms to be used to display environmental impact data are previously prepared in the server of the information provider and the information requestor is made to select one of the output forms in which the environmental impact data is displayed. Therefore, the information requestor can obtain the environmental impact data in the desired output form.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An information providing system comprising:
a server of an information provider which previously stores an environmental impact calculation program and databases of respective products required for the environmental impact calculation program; and
a computer of an information requestor,
wherein said server and said computer are connected to each other via a network to accomplish mutual communication, and said server provides environmental impact data,
wherein when providing environmental impact data, said server requests a user ID and a password, compares a user ID and a password transmitted from said computer with registered user ID and password stored in a user information file to verify the information requestor as an authorized requestor, and provides the authorized information requestor with environmental impact data.

2. The information providing system according to claim 1, wherein said server requests user information from a new information requestor, conducts registration processing of the information requestor, and issues a user ID and a password to the information requestor.

3. The information providing system according to claim 1, wherein said server has a plurality of environmental impact calculation programs, allows an information requestor to select one from the plurality of environmental impact calculation programs when the information requestor requests environmental impact data, and calculates environmental impact data based on the selected environmental impact calculation program.

4. The information providing system according to claim 1, wherein said server has a plurality of output forms to be used to display environmental impact data, allows an information requestor to select one from the plurality of output forms when displaying environmental impact data, and displays environmental impact data based on the selected output form.

5. A method of providing information from an information provider-side unit installed at the side of a party that provides certain information to an information receiver-side unit installed at the side of a party that requires the information, wherein said information provider-side unit and information receiver-side unit being connected to each other through a network, the method comprising the steps of:
storing a computer program for calculating environmental impact, a database of environmental impact data of products required for the environmental impact calculation program, and user information on identity codes and the passwords in a correlated manner;
requesting said information receiver-side unit display data corresponding to a request for inputting an identity code and a password;
receiving the identity code and the password from said information receiver-side unit and deciding whether the identity code and the password received from said information receiver-side unit belong to an authorized user or not; and
providing the environmental impact data to said information receiver-side unit only when it is decides that the identity code and the password received from said information receiver-side unit belong to an authorized user.

6. An information providing system comprising:
an information provider-side unit installed at the side of a party that provides certain information and an information receiver-side unit installed at the side of a party that requires the information, wherein said information provider-side unit and information receiver-side unit being connected to each other through a network, wherein
said information receiver-side unit having means for displaying, inputting data, and means for transmitting and receiving data to and from said information provider-side unit,
said processing unit having
a storing unit which stores a computer program for calculating environmental impact, a database of environmental impact data of products required for the environmental impact calculation program, and user information on identity codes and the passwords in a correlated manner;
a data requesting unit which makes said information receiver-side unit display data corresponding to a request for inputting an identity code and a password;
a data receiving unit which receives the identity code and the password from said information receiver-side unit;
an authentication unit which decides whether the identity code and the password received from said information receiver-side unit belong to an authorized user or not; and
information providing unit which provides the environmental impact data stored in said storing unit to said information receiver-side unit only when said authentication unit decides that the identity code and the password received from said information receiver-side unit belong to an authorized user.
